(19) United States
(12) Patent Application Publication
(10) Pub. No.: US 2013/0215630 A1
(43) Pub. Date: Aug. 22, 2013

(54) CONTROL APPARATUS AND METHOD OF VEHICULAR LAMP

(71) Applicants: Hyuk min LEE, Yongin-si (KR); In heum PARK, Yongin-si (KR)

(72) Inventors: Hyuk min LEE, Yongin-si (KR); In heum PARK, Yongin-si (KR)

(73) Assignee: HYUNDAI MOBIS Co., Ltd., Yongin-si (KR)

(21) Appl. No.: 13/595,293

(22) Filed: Aug. 27, 2012

(30) Foreign Application Priority Data
Feb. 17, 2012 (KR) 10-2012-0016447

(51) Int. Cl. B60Q 1/08

(52) U.S. Cl. 362/465

(57) ABSTRACT

Disclosed is a control method of a vehicular lamp, including: judging reliability of a camera; sensing whether there is an oncoming vehicle from an opposite lane by using the camera; moving an optical axis to an opposite side to the vehicle when the vehicle is sensed; and forming an ‘L’-shaped beam pattern.

### CROSS-REFERENCE TO RELATED APPLICATIONS

The present application claims priority to Korean Patent Application Number 10-2012-0016447 filed Feb. 17, 2012, the entire contents of which application is incorporated herein for all purposes by this reference,

### TECHNICAL FIELD Exemplary embodiments relate to a control apparatus and a control method of a vehicular lamp.

### BACKGROUND

In general, a vehicle has an illumination function and a lamp device used to notify a driving state of a vehicle to other vehicles or other road users so as to clearly see an object in a driving direction during night driving. A head lamp called a headlight as an illumination lamp serving to shine a front course which the vehicle travels requires brightness sufficient enough to verify an obstacle on a road at a distant of at least 100 m at night. A specification of the head lamp is set differently for each country and in particular, an irradiation direction of a head lamp beam is set differently depending on a right pass (left driving) or a left pass (right driving).

A vehicular head lamp generally has an illumination function used to see an object and indication, signaling, warning, and decoration functions used to notify the driving state of the self-vehicle to other vehicles or other road users.

The vehicular head lamp uses a bulb as a light source, but since the bulb has a short life-span and low impact resistance, a high-luminance light emitting diode (LED) or organic light emitting diode (OLED) has been used as the light source in recent years.

The vehicular head lamp should ensure a visual field of a driver of an oncoming vehicle from an opposite lane. To this end, methods of sensing whether there is the oncoming vehicle from the opposite lane to correspondingly turn off a full beam are presented.

### SUMMARY

Exemplary embodiments have been made in an effort to provide a control apparatus and a control method of a vehicular lamp that ensures intersafety by preventing glare of driver of an oncoming vehicle from an opposite lane.

An exemplary embodiment provides a control method of a vehicular lamp, including: judging reliability of a camera; sensing whether there is an oncoming vehicle from an opposite lane by using the camera; moving an optical axis to an opposite side to the vehicle when the vehicle is sensed; and forming an ‘L’-shaped beam pattern.

According to exemplary embodiments, a control method of a vehicular lamp can ensure intersafety by ensuring a visual field of a driver of an oncoming vehicle from an opposite lane.

According to the exemplary embodiments, the control method of a vehicular lamp can ensure the visual field of the driver of the oncoming vehicle from the opposite lane by maintaining a low beam when reliability of a camera is equal to or less than a predetermined value.

The advantages of the present invention are not limited to the advantages described above, and the other advantages not stated in the above will be clearly understood by those skilled in the art from the following description.

### BRIEF DESCRIPTION OF THE DRAWINGS

FIG. 1 is a conceptual diagram of constituent elements of a control apparatus of a vehicular lamp according to an exemplary embodiment.

FIG. 2 is a cross-sectional view showing a structure of an optical module.

FIG. 3 is a flowchart showing a sequence of a control method of a vehicular lamp according to an exemplary embodiment.

FIG. 4 is a flowchart showing a sequence of a control method of a vehicular lamb according to an exemplary embodiment.

### DETAILED DESCRIPTION

An exemplary embodiment of a lamb apparatus according to the present invention will be described with reference to the accompanying drawings. In this description, Thicknesses or sizes of constituent members shown in the drawings may be exaggeratedly illustrated for clear and easy description. Further, terms to be described below as terms defined by considering functions in the present invention may depend on a user, an operator's intention, or custom. Therefore, the terms should be defined based on contents throughout the specification.

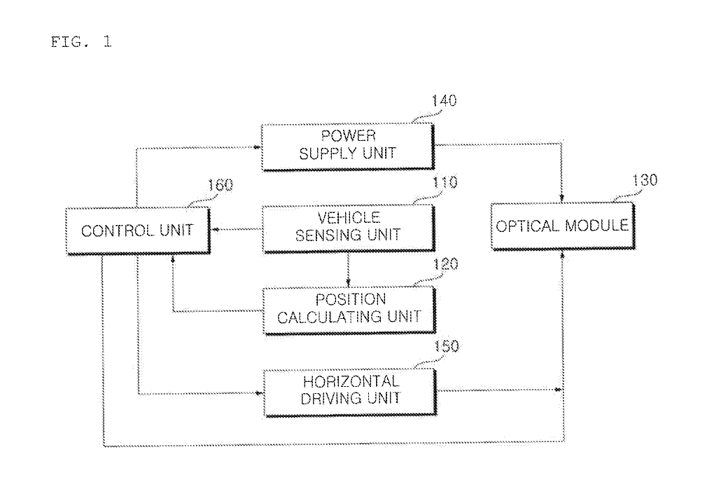

FIG. 1 is a conceptual diagram of constituent members of a control apparatus of a vehicular lamp according to an exemplary embodiment.

Referring to FIG. 1, the control apparatus of a vehicular lamp according to the exemplary embodiment may include a vehicle sensing unit 110 sensing whether there is another vehicle in front by using a camera, a position calculating unit 120 calculating a distance from another vehicle, an optical module 130 including a lens, a shield disposed at a focus of the lens, and a light source irradiating light to the lens, and a control unit 160 judging reliability of the camera.

The vehicle sensing unit 110 may include a camera (not shown). The vehicle sensing unit 110 may sense whether there is another vehicle in front. The vehicle sensing unit 110 may sense whether there is an oncoming vehicle from an opposite lane by using the camera (not shown). The vehicle sensing unit 110 may sense whether there is a preceding vehicle that travels in the same direction. The vehicle sensing unit 110 may sense whether there is a vehicle to send the resulting signal to the control unit 160.

The position calculating unit 120 may receive a signal from the control unit 160. The position calculating unit 120 may receive the signal from the control unit 160 after the shield blocks light irradiated upward from the optical module 130, but is not limited thereto. The positional calculating unit 120 may calculate the position of the vehicle in front after receiving an operation signal from the control unit 160. The position calculating unit 120 may calculate the position of the vehicle in front to send the resulting signal to the control unit 160.

A horizontal driving unit 150 may move an optical axis of the optical module 130 horizontally in response to a signal received from the control unit 160. The horizontal driving unit 150 may block light irradiated toward the oncoming vehicle from the opposite lane by controlling the optical axis of the optical module 130.

The control unit 160 may send signals to a power supply unit 140, the horizontal driving unit 150, and the optical module 130 in response to the signals received from the vehicle sensing unit 110 and the position calculating unit 120. When the control unit 160 receives the signal indicating that there is another vehicle in front from the vehicle sensing unit 110, the control unit 160 may rotate the shield of the optical module 130 to block the light irradiated upward, but is not limited thereto. The control unit 160 may control power supplied to the optical module 130 by controlling the power supply unit 140. The control unit 160 may control the optical axis of the optical module 130 horizontally by controlling the horizontal driving unit 150.

The control unit 160 may judge the reliability of the camera. The control unit 160 may judge the reliability depending on continuity of an image of the oncoming vehicle from the opposite lane, which is inputted through the camera. The control unit 160 photographs a plurality of frames continuously in the camera to thereby judge the reliability of the camera. For example, in the case where a distance from the oncoming vehicle from the opposite lane is rapidly changed by a predetermined value or more or the size of the oncoming vehicle from the opposite lane is rapidly changed, the reliability of the camera may deteriorate.

The control unit 160 may operate the position calculating unit 120 depending on the reliability of the camera. The control unit 160 may input a minimum reliability value of the camera to operate the position calculating unit 120 in advance to thereby control the position calculating unit 120. The control unit 160 may determine reliability by analyzing the image of another oncoming vehicle from the opposite lane which is continuously photographed by the camera and operate the position calculating unit 120 when the reliability is equal to or more than the minimum reliability value inputted in advance.

The control unit 160 may receive whether there is the vehicle in front from the vehicle sensing unit 110. The control unit 160 may receive the position of the vehicle oncoming from the opposite lane from the position calculating unit 120. The control unit 160 may transfer the signals to the horizontal driving unit 150, the power supply unit 140, and the optical module 130 depending on the distance from the vehicle in front.

The power supply unit 140 may receive a signal from the control unit 160. The power supply unit 140 may control power supplied to the optical module 130 depending on the signal received from the control unit 160. The power supply unit 140 may control the light intensity of the optical module 130 by controlling the power supplied to the optical module 130. The power supply unit 140 may control current supplied to the optical module 130. The power supply unit 140 may control the current supplied to the optical module 130 in the range of 1300 mA to 1 A.

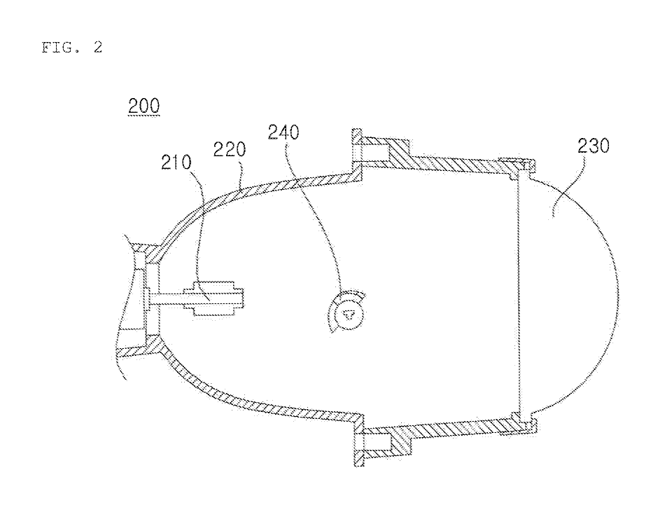

FIG. 2 is a cross-sectional view showing a structure of an optical module 200.

Referring to FIG. 2, the optical module 200 may include constituent members generating a predetermined beam pattern, such as a light source 210, a reflector 220, a lens 230, and a shield 240. The optical module 200 may form various beam patterns by driving the shield 240 and adjusting the position of the optical axis of the optical module.

The lens 230 may be an aspheric lens 230. The lens 230 may have a surface receiving light and a surface emitting light. The lens 230 may be the single-surface aspheric lens 230 of which an incident surface receiving light is a flat surface. The surface of the lens 230 emitting light may be an aspheric surface. The lens 230 may be made of a transparent optical material such as glass or plastic, but is not limited thereto.

The lens 230 may refract light. The lens 230 may refract light reflected on the reflector 220 to be incident. The lens 230 may focus light to emit the light to the outside. The lens 230 may receive light generated from the light source 210 to emit the light by increasing luminous flux. The lens 230 may straighten the light incident from the light source 210.

The light source 210 may be disposed in the reflector 220. The light source 210 may be disposed at a concave portion of the reflector 220. The light source 210 may receive power from the outside. The light source 210 may provide light to the reflector 220.

For example, the light source 210 may be a light emitting element package including a light emitting diode (LED) (not shown).

The light emitting diode (not shown) may convert an electric signal into infrared rays, visible rays, or light by using a property of a compound semiconductor. The light emitting diode (not shown) may be electrically connected with a lead frame (not shown) of the light emitting element package (not shown).

The light source 210 may provide light to a reflection. surface of the reflector 220. The light source 210 may provide light to the lens 230. The light source 210 provides light to the reflector 220 to reflect the light, which may be irradiated toward the lens 230.

The reflector 220 may receive light from the light source 210. The reflector 220 may reflect the light incident from the light source 210 by using a parabolic surface. The reflector 220 may reflect. light toward the lens 230 by using the parabolic surface.

The shield 240 may be disposed at a focus of the lens 230. The shield may be disposed in front of the lens 230 and the reflector 220 may be disposed in the rear of the lens 230. The shield 240 may rotate as a bar type, but is not limited thereto. When the shield 240 rotates in the bar type, the shield 240 may rotate at the range of 0 to 100° and allow the optical module 200 to have various beam patterns. The optical module 200 may form an ‘L’-shaped beam pattern according to the type of the shield 240.

The shield 240 may modify the beam pattern of the optical module 200 by blocking or opening light provided from the reflector 220 according to the rotational angle thereof.

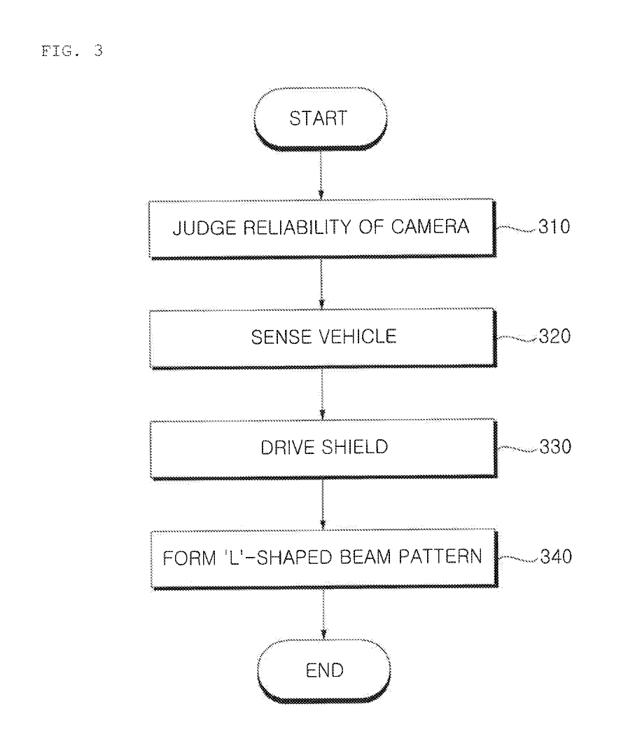

FIG. 3 is a flowchart showing a sequence of a control method of a vehicular lamp according to an exemplary embodiment.

Referring to FIG. 3, the control method of a vehicular lamp according to the exemplary embodiment includes judging reliability of a camera (310), sensing whether there is an oncoming vehicle from an opposite lane by using the camera (320), moving an optical axis to an opposite side of the vehicle when the vehicle is sensed (330), and forming an ‘L’-shaped beam pattern (340).

In the judging of the reliability of the camera (310), the reliability of the camera may be judged through an image photographed by the camera. The reliability of the camera depends on continuity of the image photographed by the camera. The continuity of the image photographed by the camera may deteriorate when a foreign material is attached to a camera lens or when bad weather occurs.

For example, the reliability of the camera may deteriorate when an object continuously photographed by the camera is rapidly changed over a predetermined range. The change of the photographed object may include a change in size of the object or a change in distance between the object and the vehicle. The change in size of the object may be a change in width or height of the object.

The object may be an object of which the position is changed. For example, the object may be another oncoming vehicle from an opposite lane of the vehicle, but is not limited thereto.

The camera may be included in a vehicle sensing unit of the vehicular lamp. The image photographed by the camera may be converted into a signal to be transferred to a control unit. The control unit may analyze the signal to determine the reliability of the camera.

In the case where the reliability of the camera is equal to or less than a predetermined value, an irradiation angle of the vehicular lamp may be controlled and an appropriate beam pattern may be formed depending on a road condition, a change in vehicle speed, a steering angle, and a state of a transmission.

In the case where the reliability of the camera is equal to or more than the predetermined value, the process may proceed to the sensing whether there is the oncoming vehicle, from the opposite lane by using the camera (320).

In the sensing whether there is the oncoming vehicle from the opposite lane by using the camera (320), the camera may photograph the image of the vehicle which is traveling on the opposite lane.

When it is not sensed whether there is the oncoming vehicle from the opposite lane in the sensing whether there is the oncoming vehicle from the opposite lane by using the camera (320), light of the vehicular lamp may be irradiated upward.

The control unit may maintain the light irradiated from the optical module upward when the vehicle sensing unit does not sense that there is another vehicle in front. The control unit may block the light irradiated upward by rotating the shield of the optical module when the vehicle sensing unit senses another vehicle in front, but is not limited thereto.

When another vehicle is sensed in front, the process may proceed to the moving of the optical axis to the opposite side to another vehicle (330).

When another vehicle is sensed in front, a direction of the light irradiated from the optical module may move to the opposite side to another vehicle in order to prevent interference of a visual field of a driver of another vehicle.

When the vehicle sensing unit senses another vehicle in front, a horizontal driving unit may more the optical axis of the optical module to the opposite side to another vehicle.

In the forming of the ‘L’-shaped beam pattern (340), the ‘L’-shaped beam pattern may be formed so as to prevent interference of the visual field of the driver of another vehicle in front.

In the forming of the ‘L’-shaped beam pattern (340), the optical module may allow the light emitted from the optical module to have the ‘L’-shaped beam pattern by changing a state of the shield. The optical module 200 may form the ‘L’-shaped beam pattern to maintain a progress direction of light from the oncoming vehicle from the opposite lane downward and light in a direction of a progress lane upward.

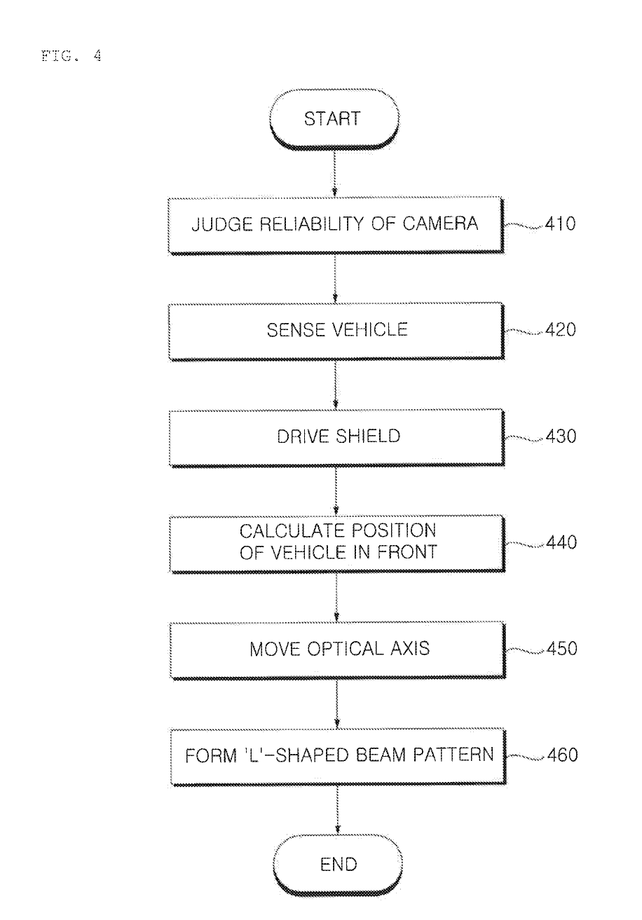

Referring to FIG. 4, the control method of a vehicular lamp according to the exemplary embodiment may include judging the reliability of the camera (410), sensing whether there is the oncoming vehicle from the opposite lane by using the camera (420), moving the optical axis to the opposite side to the vehicle when the vehicle is sensed (430), and forming the ‘L’-shaped beam pattern (460) and may further include calculating the position of the sensed vehicle (440), and moving the optical axis horizontally according to the position of the vehicle (450).

In the calculating of the position of the sensed vehicle (440), the position calculating unit may calculate the position of another oncoming vehicle from the-opposite lane. The position calculating unit may transfer a signal to the control unit. The position calculating unit may signalize the position of another oncoming vehicle from the opposite lane to transfer the signalized signal to the control unit.

In the moving of the optical axis horizontally according to the position of the vehicle (450), the optical axis may move according to a change in position of another oncoming vehicle from the opposite lane to continuously ensure the visual field of the driver of the other vehicle.

When another oncoming vehicle from the opposite lane approaches, the optical axis moves toward another vehicle to continuously maintain the light from the oncoming vehicle from the opposite lane downward, but is not limited thereto.

It will be understood to those skilled in the art that the present invention may be implemented in various ways without changing the spirit of necessary features of the present invention. Accordingly, the exemplary embodiments described above are provided as examples in the whole respects and do not limit the present invention. The scope of the present invention is defined in the following claims and all changed or modified types derived from the meanings and scope of the clams and the equivalent concept thereof should be construed as being included in the scope of the present invention.

What is claimed:

1. A control method of a vehicular lamp, comprising:
judging reliability of a camera;
sensing whether there is an oncoming vehicle from an opposite lane by using the camera;
moving an optical axis to an opposite side to the vehicle when the vehicle is sensed; and
forming an ‘L’-shaped beam pattern.

2. The control method of a vehicular lamp of claim 1, further comprising:
calculating the position of the sensed vehicle.

3. The control method of a vehicular lamp of claim 1, further comprising:
moving the optical axis horizontally depending on the position of the vehicle.

4. The control method of a vehicular lamp of claim 1, wherein in the judging of the reliability of the camera, the reliability of the camera is judged depending on the continuity of the position or size of the vehicle.

5. The control method of a vehicular lamp of claim 1, wherein the sensing of whether there is the vehicle is performed when the reliability of the camera is equal to or more than a predetermined value.

6. A control apparatus of a vehicular lamp, comprising:
a vehicle sensing unit sensing whether there is another vehicle in front by using a camera;
a position calculating unit calculating a distance from another vehicle;
an optical module comprising a lens, a shield disposed at a focus of the lens, and a light source irradiating light to the lens; and
a control unit judging reliability of the camera.

7. The control apparatus of a vehicular lamp of claim 6, wherein the optical module controls an irradiation angle of light depending on the position of another vehicle.

8. The control apparatus of a vehicular lamp of claim 6, wherein whether the position calculating unit operates is determined according to the reliability of the camera.
